(19) United States
(12) Patent Application Publication
(10) Pub. No.: US 2010/0182270 A1
(43) Pub. Date: Jul. 22, 2010

(54) ELECTRONIC DEVICE WITH TOUCH INPUT ASSEMBLY

(76) Inventors: Turan Caliskan, Malmo (SE); Idris Omerovic, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/356,714

(22) Filed: Jan. 21, 2009

(51) Int. Cl. G06F 3/045; G06F 3/041

(52) U.S. Cl. 345/174; 345/173

(57) ABSTRACT

An electronic device includes a display and a touch input assembly disposed over the display. The touch input assembly includes a first touch sensor configured to function as a general purpose user input for data entry and for controlling functions of the electronic device in coordination with content displayed on the display. The touch input assembly also includes a second touch sensor configured to receive user touch input to wake up the first touch sensor from a stand-by state of the first touch sensor.

### TECHNICAL FIELD OF THE INVENTION

The technology of the present disclosure relates generally to input devices for electronic devices and, more particularly, to an electronic device that includes a touch input assembly having a first sensor component for detecting user input and a second sensor component for activating the first sensor component.

### BACKGROUND

Some portable electronic devices, such as mobile telephones, rely on touch screen technology to receive user input. Touch screen technology typically relies on a transparent touch sensitive sensor located above a display. Some conventional touch sensitive sensors rely on capacitance changes that result from the presence and movement of a user's finger against or near the sensor surface.

These types of sensors are known to consume a relatively high amount of power that can contribute to depletion a battery's charge. Therefore, many devices with touch screen technology have a standby mode in which power to the sensor is turned off or reduced to conserve power when not actively used by the user. To fully activate the sensor for use, the user is required to undertake an action. For instance, the user may simultaneously press a mechanical button and touch a certain point on the screen. However, if the electronic device does not have any traditional mechanical keys or buttons, then this activation technique is impractical. It also would be impractical to leave the touch screen in the active state at all time due to power consumption by the touch sensor and due to sensing of inadvertent touching that may be interpreted as user input.

### SUMMARY

To enhance stand-by operation of a touch screen, the present disclosure describes an improved touch input assembly. The touch input assembly includes a capacitive sensor that senses user input and a resistive sensor that is used to sense user input to wake-up the capacitive sensor when the capacitive sensor is placed in a stand-by mode. In a typical arrangement, the touch input assembly is placed over a display to coordinate user input with displayed content. The resistive sensor may be placed over or under the capacitive sensor and may be relatively small compared to the capacitive sensor.

According to one aspect of the disclosure, an electronic device includes a display; and a touch input assembly disposed over the display, the touch input assembly including a first touch sensor configured to function as a general purpose user input for data entry and for controlling functions of the electronic device in coordination with content displayed on the display; and a second touch sensor configured to receive user touch input to wake up the first touch sensor from a stand-by state of the first touch sensor.

According to one embodiment of the electronic device, the first touch sensor is a capacitive touch sensor.

According to one embodiment of the electronic device, the second touch sensor is a resistive touch sensor.

According to one embodiment of the electronic device, the first touch sensor and the second touch sensor are in a stacked relationship over the display.

According to one embodiment of the electronic device, the second touch sensor is smaller in area than the first touch sensor.

According to one embodiment of the electronic device, the second touch sensor is between the display and the first touch sensor.

According to one embodiment of the electronic device, the first touch sensor is between the display and the second touch sensor.

According to one embodiment of the electronic device, a layer of material forms part of the first touch sensor and forms part of the second touch sensor.

According to one embodiment of the electronic device, touch input to wake up the first touch sensor involves a predetermine sequence of touches.

According to one embodiment of the electronic device, touch input to wake up the first touch sensor involves at least one touch a first portion of the second touch sensor and at least one touch of a second portion of the second touch sensor.

According to one embodiment, the electronic device further includes a control circuit that controls operation of the electronic device.

According to one embodiment of the electronic device, the touch input assembly further includes an interface circuit that detects valid touch inputs to the first and second touch sensors and outputs corresponding control signals to the control circuit.

According to one embodiment of the electronic device, the touch input to wake up the first touch sensor results in the generation of an interrupt signal that is input to the control circuit.

According to one embodiment of the electronic device, the second touch sensor is outside a viewable area of the display.

According to one embodiment of the electronic device, the second touch sensor is inside a viewable area of the display.

According to one embodiment of the electronic device, the touch input to wake up the first touch sensor also wakes up the display from a stand-by state of the display.

According to one embodiment of the electronic device, the touch input assembly further includes a third touch sensor configured to receive additional touch input to wake up the first touch sensor from the stand-by state in coordination with the touch input received by the second touch sensor so that the touch input to wake up the first touch sensor involves at least one touch the second touch sensor and at least one touch of the third touch sensor.

According to one embodiment of the electronic device, the electronic device is a mobile telephone.

According to another aspect of the disclosure, a touch input assembly for an electronic device includes a first touch sensor configured to function as a general purpose user input for data entry and for controlling functions of the electronic device; and a second touch sensor configured to receive user touch input to wake up the first touch sensor from a stand-by state of the first touch sensor.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that includes a touch input assembly;

FIG. 2 is a schematic block diagram of the electronic device of FIG. 1 while operating as part of a communications system;

FIG. 3 is a schematic side view of an exemplary embodiment of the touch input assembly;

FIG. 4 is a schematic top view of the touch input assembly of FIG. 3; and

FIG. 5 is a schematic side view of another exemplary embodiment of the touch input assembly.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

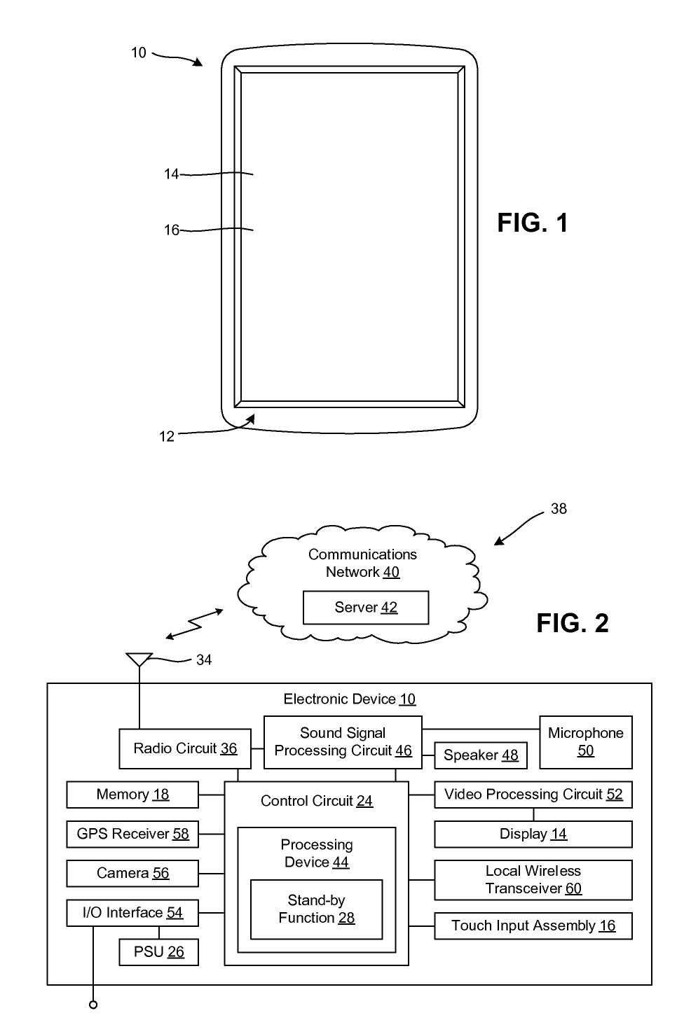

Referring initially to FIGS. 1 and 2, an electronic device 10 is shown. The electronic device 10 includes a touch screen 12. The touch screen 12 may include a display 14 and a touch input assembly 16 located over the display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 18 (FIG. 2) of the electronic device 10. The display 14 may be used to present images, video and other graphics to the user such as, but not limited to, photographs, mobile television content, Internet pages, and video associated with games.

As indicated, the display 14 and touch input assembly 16 may be used in conjunction with one another to implement touch screen functionality. For instance, the display 14 may display content to the user in the form of menus, representations of alphanumeric keys, links, and so forth. The user may touch (e.g., tap) a sensor component of the touch input assembly 16 to select a desired item of displayed content. Still other touch motions (e.g., touching and dragging a finger) may be used for other input purposes, such as writing, navigation, scrolling, moving a displayed item, etc.

The exemplary illustration of FIG. 1 shows the display 14 and touch input assembly 16 as being bezel-set into a housing of the electronic device 10. It will be appreciated that the display 14 and touch input assembly 16 may be retained without a bezel so as to be substantially flush with the housing of the electronic device 10.

In one embodiment, the electronic device 10 does not have any user input buttons or keys for text or navigation input. For instance, it may be possible that the only button present on the electronic device is an on/off power button. In other embodiments, keys may be accessed by sliding, pivoting or turning a housing portion of the electronic device 10 to expose keys that are retained by another portion of the electronic device 10. However, these keys may be covered when the electronic device is not opened in this manner. Therefore, the form factor and/or use arrangement (e.g., open or closed configuration) may be such that the electronic device 10, at any time or at some times, has no keys or buttons that may be used to “wake-up” the display and/or touch sensing functionality.

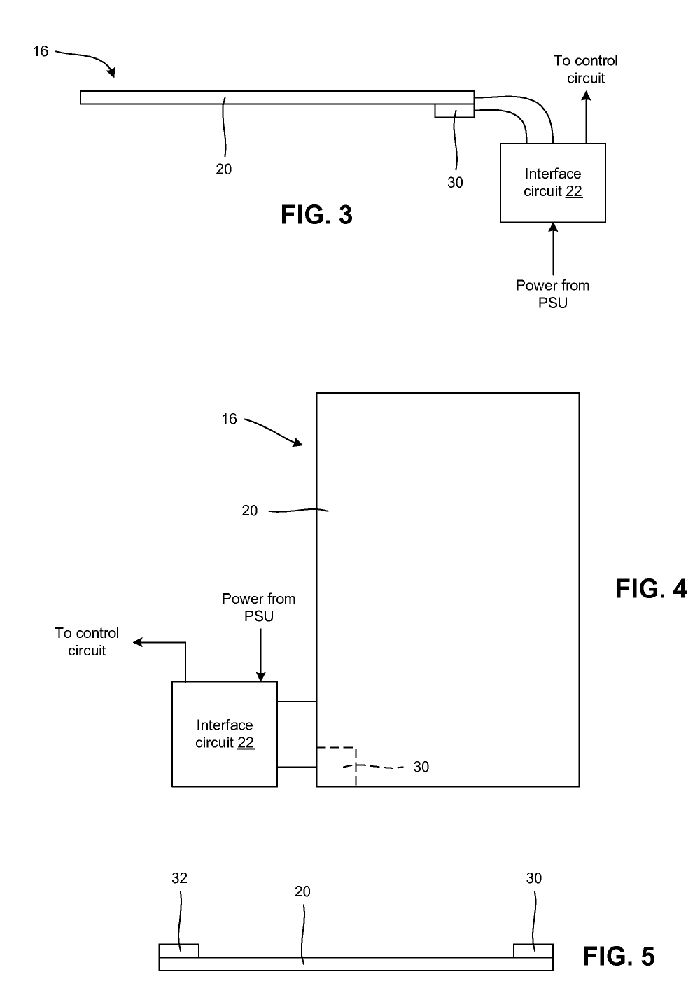

With additional reference to FIGS. 3 and 4, the touch input assembly 16 is configured to sense user touch input when in an active state and to sense user touch input to transition the touch input assembly 16 from a stand-by state to the active state. In one embodiment, the touch input device 16 includes a first touch sensor and a second touch sensor for these purposes. In one embodiment, the first touch sensor may be a capacitive touch sensor 20 that is used to sense user input when the touch assembly 16 is in the active mode. The capacitive touch sensor 20 may be large enough to cover portions of the display 14 that are meant to be touch sensitive to receive user input from a finger or stylus.

Capacitive touch sensors are generally known in the art and will not be described in detail. Capacitive touch sensors typically include a layer that conducts a continuous electrical current across the sensor. The sensor, therefore, exhibits precisely controlled electric fields in the horizontal and vertical directions to achieve a capacitance. When a finger or other member that exhibits capacitance touches or nears the sensor, capacitance changes in the sensor caused by the object may be sensed by sensing components of the capacitive touch sensor. Output signals of the sensed capacitance changes may be analyzed to generate meaningful user input. Capacitive touch sensors often include at least one conductive layer and one or more highly transparent substrate layers made from, for example, films or glass plates. In some arrangements, the conductive layer may be a coating, such as indium tin oxide, that is formed on a substrate layer.

The capacitive touch sensor 20 has an active mode (also referred to as a scanning mode) during which current flows through the sensor 20 and output signals are generated. The output signals may be input to an interface circuit 22 that analyzes the signals for valid touch motions and outputs corresponding control signals for the valid touch motions. The control signals may be input to a control circuit 24 (described below) that controls the electronic device 10 to undertake action in response to the control signals. In other embodiments, the signals output by the sensor 20 may be input directly to the control circuit 24 for processing.

As will be appreciated, the current consumption of the capacitive touch sensor 20 is a power load that contributes to the depletion of charge stored by a power supply unit (PSU) 26 used to power the electronic device in the absence of an external power source. The PSU 26 may include, for example, a rechargeable battery to deliver operating power to the capacitive touch sensor 20 and other power consuming components of the electronic device 10.

To conserve energy resources, the electronic device 10 may include a stand-by function 28 that manages power consumption of components of the electronic device 10. Additional details and operation of the stand-by function 28 will be described in greater detail below. The stand-by function 28 may be embodied as executable instructions (e.g., code) that is resident in and executed by the electronic device 10. In one embodiment, the stand-by function 28 may be one or more programs that are stored on a computer or machine readable medium. The stand-by function 28 may be a stand-alone software application or may form a part of a software application that carries out additional tasks related to the electronic device 10. While the stand-by function 28 is implemented in software in accordance with an embodiment, such functionality could also be carried out via dedicated hardware or firmware, or some combination of hardware, firmware and/or software.

The stand-by function 28 may be configured to place the capacitive touch sensor 20 in a stand-by state during periods of user inactivity with the electronic device 10. For example, the user may command entry into the stand-by mode through a sequence of touch inputs using the capacitive touch sensor 20. Also, if no valid touch input has been sensed for a predetermined period of time, the stand-by mode may be entered. In the stand-by mode, the scanning operation of the capacitive touch sensor 20 may be stopped and energy may be conserved by reducing or eliminating the current flow through the sensor 20.

The stand-by function 28 also may place the display 14 and/or another component or components of the electronic device 10, such as a transceiver, in stand-by mode from an active state during periods of inactivity. It is noted that there may be instances where the display 14 is active but the capacitive touch sensor 20 is not active. For example, if the user is watching video, but not using the sensor 20, the display 14 may be active and the sensor 20 may be in the stand-by state.

The second touch sensor may be present to sense touching that will cause the stand-by function 28 to “wake-up” the sensor 20 to receive user input by returning the sensor 20 to the active state from the stand-by state. In appropriate circumstances, the input sensed by the second touch sensor to wake-up the sensor 20 also may be used to wake-up the display 14 or other component.

In one embodiment, the second touch sensor is a resistive touch sensor 30. The resistive touch sensor 30 may be relatively small in size compared to the capacitive touch sensor 20. For instance, in an exemplary embodiment, the resistive touch sensor 30 may have an area that is about 0.25 square centimeters to about six square centimeters, whereas the capacitive touch sensor 20 is commensurate in size with the display 14. Mobile telephones, for example, typically have touch-enabled displays that are around 25 square centimeters or larger.

In one embodiment, the resistive touch sensor 30 may be thought of as a dedicated touch sensor for waking up the capacitive touch sensor 20 and/or other components of the electronic device 10. Also, when active, the capacitive touch sensor 20 may be thought of as a general purpose user input for inputting data (e.g., text) and controlling some or all of the functions of the electronic device 10.

In one embodiment, as illustrated in FIGS. 3 and 4, the resistive touch sensor 30 is located under the capacitive touch sensor 20 (e.g., between the capacitive touch sensor 20 and the display 14). In another embodiment, as illustrated in FIG. 5, the resistive touch sensor 30 is located over the capacitive touch sensor 20 (e.g., on a side of the capacitive touch sensor 20 that is distal the display 14). It is contemplated that when the resistive touch sensor 30 is on top of the capacitive touch sensor 20, the resistive touch sensor 30 will not interfere with touch sensing by the capacitive touch sensor 20. Also, when the resistive touch sensor 30 is under the capacitive touch sensor 20, the capacitive touch sensor 20 will not interfere with touch sensing by the resistive touch sensor 30.

The resistive touch sensor 30 may be placed anywhere with respect to the display 14, including inside and/or outside a viewable area of the display 14. It is possible that in the area of the resistive touch sensor 30, light transmission from the display 14 through the touch input assembly 16 may be lower than in areas where just the capacitive touch sensor 20 is present. But it is contemplated that the sensors 20 and 30 are translucent enough so that their combined presence is imperceptible to the user or not bothersome to the user. Also, if desired, the resistive touch sensor 30 may be placed in an area where it is predicted that there will be relatively little touching for user input functions using the capacitive touch sensor 20 and/or in an area where it is predicted that there will be relatively little display of “important” content using the display 14.

Resistive touch sensors are generally known in the art and will not be described in detail. Resistive touch sensors typically include two electrically conductive and resistive layers separated by a space. Substrates of glass or film also may be present to support the conductive layers. In some cases, a film substrate layer also may be conductive and serve as the conductive layer. When two glass substrates are present, the sensor may be referred to as a glass-glass sensor. When two film substrates are present, the sensor may be referred to as a film-film sensor. In another arrangement, a film substrate and a glass substrate may be present, in which case the sensor may be referred to as a film-glass sensor. When an object (e.g., a user's finger or stylus) touches the sensor or applies sufficient pressure to the sensor through another component (e.g., the capacitive touch sensor 20), the conductive layers may come in contact with one another at a certain point. When contacted in this manner, the panel then electrically acts similar to two voltage dividers (e.g., one in the horizontal direction and one in the vertical direction). This causes a change in the electrical current that may be registered as a touch event by an interface circuit (e.g., the interface circuit 22) and corresponding control signals may be sent to a controller (e.g., the controller 24) for processing.

In one embodiment, a film layer or a glass layer of the resistive touch sensor 30 may be the same layer as a film or a glass layer of the capacitive touch sensor 20. In this manner, the sensors 20 and 30 share one or more layers of material.

In the case of the illustrated resistive touch sensor 30, the resistive touch sensor may output signals to the interface circuit 22. The interface circuit 22 may monitor the signals for indications of touching (e.g., a signal that exceeds a predetermined threshold). Upon detection of such a touching, the interface circuit may output a control signal to the control circuit 24. In other embodiments, the resistive touch sensor 30 may output signals directly to the control circuit 24. In one embodiment, the control signal that is input to the control circuit 24 in response to detected touching is an interrupt signal, indicating a need for a change in state or processing by the stand-by function 28 provided the capacitive touch sensor 20 is in the stand-by state.

More specific operation of the sensors 20 and 30 in conjunction with the stand-by function 28 now will be described in greater detail. In an active mode for touch sensing, the capacitive touch sensor 20 is placed in an active state and scans for valid touch input. The display 14 typically will be active when the touch sensing is active. Also, the resistive touch sensor 30 may be active when touch sensing using the capacitive touch sensor 20 is active. In this case, any interrupt signals received from the touch input assembly 16 may be ignored by the control circuit 24. In another embodiment, the resistive touch sensor 30 may be in a stand-by state when touch sensing using the capacitive touch sensor 20 is active.

When the capacitive touch sensor 20 is in an inactive state (e.g., the stand-by state), the resistive touch sensor 30 may be in an active state. When “wake-up touching” of the resistive touch sensor 30 is detected, the control circuit 24 will activate the capacitive touch sensor 20 so that full touch input functionality of the touch input assembly 16 will be available. Also, any other components of the electronic device 10 that were in a standby mode also may be woken up, such as the display 14, communications circuitry, and so forth.

The wake-up touching may be a specific user action or actions. For example, the wake-up touching may be as simple as a single tap against the area of the resistive touch sensor 30. But it is possible that inadvertent touching of this area may result in the detection of a tap and, in turn, may lead to waking up of the functions of the electronic device 10. Therefore, the wake-up touching may be more elaborate than a single tap. For example, the wake-up touching may be pressing and holding the area of the resistive touch sensor 30 for a predetermined amount of time. Another exemplary wake-up touching may be a predefined sequence of touching. The pattern of touching may be, for example, multiple taps (e.g., two or more taps occurring within a predetermined amount of time), a pattern of taps (e.g., a single tap followed by two “quick taps”), or some other combination of taps, movement over, and/or holding of the area of the resistive touch sensor 30.

With additional reference to FIG. 5, a second resistive touch sensor 32 may be present. Similar to the first resistive touch sensor 30, the second resistive touch sensor 32 may be positioned above or below the capacitive touch sensor 20 and/or may share a layer with the capacitive touch sensor 20. The second resistive touch sensor 32, which may be spaced apart from the resistive touch sensor 30, introduces a second area that may form part of the wake-up touching that is more involved than if a single resistive touch sensor were present. In this embodiment, the wake-up touching may include simultaneous touching of the resistive touch sensors 30 and 32 (e.g., pressing and holding of one sensor and tapping of the other sensor, or pressing and holding of both sensors), or some pattern of touching involving at least one touch of the first resistive touch sensor 30 and at least one touch of the second resistive touch sensor 32 (e.g., tapping the first sensor twice followed by a single tap of the second sensor).

In another embodiment, there may be just one resistive touch sensor 30 that is configured to accept touch input in two or more locations that are spaced apart from one another. In this manner, the wake-up touching may include simultaneous touching of the portions of the resistive touch sensor 30 (e.g., pressing and holding of one portion and tapping of the other portion, or pressing and holding of both portions), or some pattern of touching involving at least one touch of the first portion and at least one touch of the second portion (e.g., tapping the first portion twice followed by a single tap of the second portion).

In the embodiments disclosed thus far, the capacitive touch sensor 20 and the resistive touch sensor 30 have relatively high transparency and are in stacked relationship over the display 14 to form a touch screen 12. It will be appreciated that there may be other contexts in which one touch sensor may be used to wake-up another touch sensor. Therefore, the capacitive touch sensor 20 and the resistive touch sensor 30 need not be stacked over one another and/or need not have high transparency. As an example, the capacitive touch sensor 30 may be positioned over the display 14 and the resistive touch sensor may be retained elsewhere on the housing of the electronic device 10. As another example, the capacitive touch sensor 20 may be substantially opaque and retained by a housing that separately retains the display 14 in another location or does not retain a display 14 at all. In this example, the resistive touch sensor 30 may be positioned over, under, or adjacent the capacitive touch sensor 20.

With continued reference to FIG. 2, additional features of the electronic device 10 when implemented as a mobile telephone will be described. The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 20, executing applications to allow user interaction with the data, displaying video and/or image content associated with the data, outputting audio sounds associated with the data, and so forth.

In the exemplary embodiment, the communications circuitry may include an antenna 34 coupled to a radio circuit 36. The radio circuit 36 includes a radio frequency transmitter and receiver for transmitting and receiving signals via the antenna 34. In this manner, the radio circuit 36 may be configured to operate in a mobile communications system 38. Radio circuit 36 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 34 and the radio circuit 36 may represent one or more than one radio transceiver.

The system 38 may include a communications network 40 having a server 42 (or servers) for managing calls placed by and destined to the electronic device 10, transmitting data to and receiving data from the electronic device 10 and carrying out any other support functions. The server 42 communicates with the electronic device 10 via a transmission medium. The transmission medium may be any appropriate device or assembly, including, for example, a communications base station (e.g., a cellular service tower, or “cell” tower), a wireless access point, a satellite, etc. The network 40 may support the communications activity of multiple electronic devices 10 and other types of end user devices. As will be appreciated, the server 42 may be configured as a typical computer system used to carry out server functions and may include a processor configured to execute software containing logical instructions that embody the functions of the server 42 and a memory to store such software. In alternative arrangements, the electronic device 10 may wirelessly communicate directly with another electronic device 10 (e.g., another mobile telephone or a computer) and without an intervening network.

As indicated, the electronic device 10 may include the primary control circuit 24 that is configured to carry out overall control of the functions and operations of the electronic device 10. The control circuit 24 may include a processing device 44, such as a central processing unit (CPU), microcontroller or microprocessor. The processing device 44 executes code stored in a memory (not shown) within the control circuit 24 and/or in a separate memory, such as the memory 18, in order to carry out operation of the electronic device 10. For instance, the processing device 44 may execute code that implements the stand-by function 28. The memory 18 may be, for example, one or more of a buffer, a flash memory, a hard drive, a removable media, a volatile memory, a non-volatile memory, a random access memory (RAM), or other suitable device. In a typical arrangement, the memory 18 may include a non-volatile memory for long term data storage and a volatile memory that functions as system memory for the control circuit 24. The memory 18 may exchange data with the control circuit 24 over a data bus. Accompanying control lines and an address bus between the memory 18 and the control circuit 24 also may be present.

In one embodiment, a portion of the control circuit 24 that carries out the stand-by function 28 may be a general purpose input/output (GPIO). For instance, the processing device 44 may be a GPIO that has connections to interface with the interface circuit 22 of the touch input assembly 16 or to interface directly with the capacitive touch sensor 20 and the resistive touch sensor 30. Control signals output by the processing device 44 may control switching of power to the capacitive touch sensor 20 and, if applicable, the resistive touch sensor 20. Therefore, the processing device 44 may read digital or other electrical signals from other parts of the electronic device 10 and output control signals to control other parts of the electronic device 10. As indicated, the signal input to the processing device 44 that corresponds to touching of the resistive touch sensor 30 may be an interrupt signal (e.g., a CPU interrupt). In another embodiment, the interface circuit 22 may be implemented with a GPIO that executes the stand-by function 28 and outputs signals used by higher level processing carried out in the processing device 44 of the control circuit 24. Also, if the processing device 44 is a dedicated GPIO or other dedicated device, a general purpose processor for carrying out other functions of the electronic device 10 also may be present as part of the control circuit 24.

The electronic device 10 may further includes a sound signal processing circuit 46 for processing audio signals transmitted by and received from the radio circuit 36. Coupled to the sound processing circuit 46 are a speaker 48 and a microphone 50 that enable a user to listen and speak via the electronic device 10. The radio circuit 36 and sound processing circuit 46 are each coupled to the control circuit 24 so as to carry out overall operation. Audio data may be passed from the control circuit 24 to the sound signal processing circuit 46 for playback to the user. The audio data may include, for example, audio data from an audio file stored by the memory 18 and retrieved by the control circuit 24, or received audio data such as in the form of voice communications or streaming audio data from a mobile radio service. The sound processing circuit 46 may include any appropriate buffers, decoders, amplifiers and so forth.

The display 14 may be coupled to the control circuit 24 by a video processing circuit 52 that converts video data to a video signal used to drive the display 14. The video processing circuit 52 may include any appropriate buffers, decoders, video data processors and so forth. The video data may be generated by the control circuit 24, retrieved from a video file that is stored in the memory 18, derived from an incoming video data stream that is received by the radio circuit 36 or obtained by any other suitable method.

The electronic device 10 may further include one or more input/output (I/O) interface(s) 54. The I/O interface(s) 54 may be in the form of typical mobile telephone I/O interfaces and may include one or more electrical connectors. The I/O interfaces 54 may form one or more data ports for connecting the electronic device 10 to another device (e.g., a computer) or an accessory (e.g., a personal handsfree (PHF) device) via a cable. Further, operating power may be received over the I/O interface(s) 54 and power to charge a battery of the power supply unit (PSU) 26 may be received over the I/O interface(s) 54.

The electronic device 10 also may include various other components. For instance, a camera 56 may be present for taking digital pictures and/or movies. Image and/or video files corresponding to the pictures and/or movies may be stored in the memory 18. A position data receiver, such as a global positioning system (GPS) receiver 58, may be involved in determining the location of the electronic device 10. A local wireless interface device 60, such as an infrared transceiver and/or an RF transceiver (e.g., a Bluetooth chipset) may be used to establish communication with a nearby device, such as an accessory (e.g., a PHF device), another mobile radio terminal, a computer or another device.

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
a display; and
a touch input assembly disposed over the display, the touch input assembly including:
a first touch sensor configured to function as a general purpose user input for data entry and for controlling functions of the electronic device in coordination with content displayed on the display; and
a second touch sensor configured to receive user touch input to wake up the first touch sensor from a stand-by state of the first touch sensor.

2. The electronic device of claim 1, wherein the first touch sensor is a capacitive touch sensor.

3. The electronic device of claim 2, wherein the second touch sensor is a resistive touch sensor.

4. The electronic device of claim 3, wherein the capacitive touch sensor and the resistive touch sensor are in a stacked relationship over the display.

5. The electronic device of claim 4, wherein the resistive touch sensor is smaller in area than the capacitive touch sensor.

6. The electronic device of claim 4, wherein the resistive touch sensor is between the display and the capacitive touch sensor.

7. The electronic device of claim 4, wherein the capacitive touch sensor is between the display and the resistive touch sensor.

8. The electronic device of claim 4, wherein a layer of material forms part of the capacitive touch sensor and forms part of the resistive touch sensor.

9. The electronic device of claim 1, wherein the first touch sensor and the second touch sensor are in a stacked relationship over the display.

10. The electronic device of claim 9, wherein the second touch sensor is smaller in area than the first touch sensor.

11. The electronic device of claim 1, wherein touch input to wake up the first touch sensor involves a predetermine sequence of touches.

12. The electronic device of claim 1, wherein touch input to wake up the first touch sensor involves at least one touch a first portion of the second touch sensor and at least one touch of a second portion of the second touch sensor.

13. The electronic device of claim 1, further comprising a control circuit that controls operation of the electronic device.

14. The electronic device of claim 13, wherein the touch input assembly further includes an interface circuit that detects valid touch inputs to the first and second touch sensors and outputs corresponding control signals to the control circuit.

15. The electronic device of claim 13, wherein the touch input to wake up the first touch sensor results in the generation of an interrupt signal that is input to the control circuit.

16. The electronic device of claim 1, wherein the second touch sensor is outside a viewable area of the display.

17. The electronic device of claim 1, wherein the second touch sensor is inside a viewable area of the display.

18. The electronic device of claim 1, wherein the touch input to wake up the first touch sensor also wakes up the display from a stand-by state of the display.

19. The electronic device of claim 1, wherein the touch input assembly further includes a third touch sensor configured to receive additional touch input to wake up the first touch sensor from the stand-by state in coordination with the touch input received by the second touch sensor so that the touch input to wake up the first touch sensor involves at least one touch the second touch sensor and at least one touch of the third touch sensor.

20. A touch input assembly for an electronic device, comprising:
a first touch sensor configured to function as a general purpose user input for data entry and for controlling functions of the electronic device; and
a second touch sensor configured to receive user touch input to wake up the first touch sensor from a stand-by state of the first touch sensor.
